(19) United States
(12) Patent Application Publication
(10) Pub. No.: US 2021/0310748 A1
(43) Pub. Date: Oct. 7, 2021

(54) SYSTEM AND METHOD FOR STORING AND RELEASING HEAT COMPRISING A BED OF PARTICLES AND THERMAL REGULATION MEANS

(71) Applicant: IFP Energies nouvelles, Rueil-Malmaison Cedex (FR)

(72) Inventors: Elena SANZ, FRANCHEVILLE (FR); Willi NASTOLL, LYON (FR); Cecile PLAIS, LES HAIES (FR)

(21) Appl. No.: 15/999,816

(22) PCT Filed: Jan. 30, 2017
(86) PCT No.: PCT/EP2017/051931

§ 371 Date: Apr. 14, 2021

(30) Foreign Application Priority Data
Feb. 19, 2016 (FR) 1651353

(51) Int. Cl. F28D 20/00; F28D 20/02; F28F 27/02

(52) U.S. Cl. CPC F28D 20/0056; F28D 20/023; F28D 20/028; F28D 2020/006; F28D 2020/0021; F28D 2020/0065; F28F 27/02

(57) ABSTRACT

The present invention relates to a system and a process for storing and releasing heat comprising at least one bed of particles (2) for storing heat. The system also comprises, at each end of the fixed bed, a means for thermal regulation of the particles (5).

Moreover, the invention relates to a system and a process for storing and recovering energy by compressed gas utilizing such a system for storing and releasing heat.

The present invention relates to the field of storing and releasing heat, in particular for storing heat in a system or a process of the AA-CAES (“Advanced Adiabatic—Compressed Air Energy Storage”) type.

In a compressed air energy storage (CAES) system, the energy, that one wishes to use at another time, is stored in the form of compressed air. For storage, a form of energy in particular electrical energy, drives air compressors and, for the release, the compressed air drives turbines, which can be connected to an electricity generator. The yield of this solution is not optimal, as part of the energy of the compressed air remains in the form of heat, which is not used. In fact, in the CAES processes, only the mechanical energy of the air is used, i.e. all the heat produced during compression is wasted. By way of example, air compressed at 8 MPa (80 bar) heats up during compression to approximately 150° C., but it is cooled before storage. In addition, the yield of a CAES system is not optimal, because the system then requires the stored air to be heated in order to produce expansion of the air. In fact, if the air is stored at 8 MPa (80 bar) and at ambient temperature, and if it is desired to recover the energy by an expansion, the decompression of the air again follows an isentropic curve, but this time starting from the initial storage conditions (approximately 8 MPa and 300 K namely approximately 27° C.). The air is therefore cooled to unrealistic temperatures (83 K namely −191° C.). It is therefore necessary to reheat it, which can be done with a burner using gas or another fuel.

Several variants to this system currently exist. In particular the following systems and processes can be mentioned:
ACAES (“Adiabatic Compressed Air Energy Storage”) in which the air is stored at high temperature due to the compression. However, this type of system requires a specific, storage system that is bulky and expensive (adiabatic storage).
AA-CAES (“Advanced Adiabatic—Compressed Air Energy Storage”) in which the air is stored at ambient temperature, and the heat due to the compression is also stored, separately, in a thermal energy storage (TES) system. The heat stored in the TES is used to heat the air before its expansion. According to certain envisaged designs, the heat is stored in the storage system using solid particles.

Moreover, such heat exchange systems are used in other fields: the storage of solar, marine energy, in metallurgy processes, etc.

One of the design criteria of the heat exchange and storage systems is their ability to control the thermal stratification (or thermocline) from low temperatures to high temperatures. In fact, the yield and the efficiency of the heat storage depend on it.

For this purpose, several types of heat exchange system have been developed. Certain types of heat exchange system involve a fixed bed of solid particles, a mobile bed of solid particles, in which there are heat exchanges of fluids circulating in co-current, etc. However, these heat exchanges are not optimal in terms of efficiency and yield.

For example, patent application FR2990502 relates to a heat storage tank with improved thermal stratification. For this heat storage system, the heat exchange is carried out using a matrix of solid particles distributed in several stages of a fixed bed, and a heat transfer fluid passing through the spaces between the stages. This design allows a homogenization of the temperature in the storage system. However, this system does not allow a good maintenance of the thermal gradient in the tank.

According to another example described in patent application WO 2013015834, the system consists of controlling the transfer of the gas between different fixed beds or different tanks, when the output temperature of the gas is below a threshold, i.e. when a certain quantity of heat has been stored in the fixed bed. However, this system is bulky, and does not appear to be optimal in terms of efficiency.

FIG. 1 shows a conventional system for storing and releasing heat 1 according to the prior art, during a charging phase (storage) CH, and during a discharging phase (releasing) DE. This system for storing and releasing heat 1 is substantially in the form of a column which comprises a fixed bed of particles 2, and means for injecting and/or drawing off 3 the fluid which will exchange heat with the particles. According to this configuration, for the charging, the fluid enters hot, at a temperature T1, via the top of the column, and leaves cold (cooled by the particles which store part of the heat of the fluid), at a temperature T2 (T2<T1), via the bottom of the column. For the discharging, the fluid enters cold, at a temperature T2, via the bottom of the column, and leaves hot (heated by the particles which release part of the heat of the particles), at a temperature T1. For this embodiment of the prior art, no temperature is imposed on the bed of particles; as a result, these temperatures drift over time, which does not allow an optimal efficiency of the system for storing and releasing heat.

FIG. 6 shows the “standard” thermal profile of the system for storing and releasing heat (TES: Thermal Energy Storage) in a fixed bed of particles, shown in FIG. 1. In this figure, the “hot side” (input and output of the hot fluid) is to the left, and the “cold side” (input and output of the cold fluid) is to the right. In this figure, the curve Tch in a solid line corresponds to the temperature profile during charging, and the curve Tde, in a dotted line, represents the temperature profile during discharging. A gradient is established between the two sides of the TES, but this gradient moves along the bed of particles during the charging and discharging cycles. Therefore a variation exists in the temperature level in the hot side (and in the cold side) as a function of time (phase in the cycle). In the discharging phase, the fluid cannot therefore recover all the stored energy, and during the charging phase the output fluid of the TES does not cool enough. In addition, this phenomenon is amplified over time, the gradient having a tendency to flatten out until a semi-stationary state is reached. The consequence of this phenomenon is a reduction in the overall efficiency of the system (less energy is recovered). In addition, in the case of the use of the system for storing and releasing heat for a process of the AA-CAES type, a reduction is also noted in the stability of the AA-CAES process, which must operate with turbine input temperatures and in the compressed air storage system which are variable. Thus, the efficiency of the turbines and the compressors of the process of the AA-CAES type is reduced, as it is a function of the input temperature.

In order to overcome these drawbacks, the present invention relates to a system for storing and releasing heat comprising at least one bed of particles for storing heat. The system also comprises, at each end of the fixed bed, a means for the thermal regulation of the particles. Thus, it is possible to regulate the temperature at the inputs/outputs of the fixed bed, which allows a good maintenance of the thermal gradient in the fixed bed, in this way ensuring a better thermal transfer during the charging or discharging of heat.

### The System and the Process According to the Invention

The invention relates to a system for storing and releasing heat comprising at least one bed of particles for storing heat, and means for injecting a fluid into, and drawing it off from said bed of particles. Said system for storing and releasing heat comprises at each end of said bed of particles a means for the thermal regulation of said particles.

According to an embodiment of the invention, said storage system comprises a first thermal regulation means capable of heating said particles at a first end of said bed of particles, and a second thermal regulation means capable of cooling said particles at a second end of said bed of particles.

According to an implementation, said thermal regulation means comprises means for heating and/or cooling said particles.

According to an aspect, said means for heating and said means for cooling the first and second thermal regulation means are connected using a heat pump device.

According to a design, said means for heating and/or for cooling said particles comprise a heat exchanger and/or an electrical resistor and/or means for circulating a thermal fluid.

According to a variant, said means for heating and/or for cooling are situated within said bed of particles.

Alternatively, said means for heating and/or for cooling are situated on the periphery of said bed of particles.

According to a characteristic, said fixed bed comprises a layer of thermally insulating material, within said bed of particles, delimiting said thermal regulation means.

Advantageously, said system for storing and releasing heat comprises means for measuring the temperature of said particles.

Preferably, said fluid is a gas, in particular air.

Advantageously, said particles are particles of phase change material.

Moreover, the invention relates to a system for storing and recovering energy by compressed gas comprising at least one gas compression means, at least one means for storing compressed gas, at least one means for expanding said compressed gas in order to generate energy, and at least one system for storing and releasing heat according to one of the preceding characteristics.

In addition, the invention relates to a process for storing heat, which comprises the following steps:
a) circulating a fluid in a bed of heat storage particles of a system for storing and releasing heat according to one of the preceding characteristics; and
b) storing part of the heat of said fluid in said particles, and regulating the temperature of said particles at at least one end of said bed of particles.

Moreover, the invention relates to a process for releasing heat, which comprises the following steps:
a) storing the heat in a bed of heat storage particles of a system for storing and releasing heat according to one of the preceding characteristics, by regulating the temperature of said particles at at least one end of said bed of particles; and
b) circulating a fluid in said bed of particles in order to release said heat from said particles to said fluid.

Moreover, the invention relates to a process for storing and recovering energy by compressed gas, which comprises the following steps using a system for storing and recovering energy by compressed gas according to the preceding characteristics:

a) compressing a gas;

b) cooling a gas in a system for storing and releasing heat;

c) storing said cooled gas;

d) heating said cooled gas in said system for storing and releasing heat; and

e) expanding said heated compressed gas in order to generate energy.

According to an embodiment, between the steps of cooling the gas and heating the gas, the temperature is regulated at at least one end of said bed of particles.

According to an implementation, in step b), the temperature of said bed of particles is regulated by heating said particles at the end of said bed of particles through which said gas has left.

Advantageously, in step d), the temperature of said bed of particles is regulated by cooling said particles at the end of said bed of particles through which said gas has left.

### BRIEF PRESENTATION OF THE FIGURES

Other characteristics and advantages of the process according to the invention will become apparent on reading the following description of non-limitative embodiment examples, with reference to the attached figures which are described below.

FIG. 1, already described, shows a system for storing and releasing heat according to the prior art, for a charging phase and for a discharging phase.

FIG. 2 shows a system for storing and releasing heat according to a first embodiment of the invention.

FIG. 3 shows a system for storing and releasing heat according to a second embodiment of the invention.

FIG. 4 shows a system for storing and releasing heat according to a third embodiment of the invention.

FIG. 5 shows a duty cycle of a system for storing and releasing of heat according to an embodiment of the invention.

FIGS. 6 and 7 represent the thermocline within a heat storage system, at the end of charging and at the end of discharging, for a storage system according to the prior art and according to the invention respectively.

FIG. 8 shows a system for storing and recovering energy by compressed gas according to an embodiment of the invention.

### DETAILED DESCRIPTION OF THE INVENTION

The present invention relates to a system for storing and releasing heat. According to the invention, the system for storing and releasing heat comprises at least one bed of heat storage particles. The system according to the invention makes it possible to store the heat originating from a hot fluid, the storage being carried out by the heat storage particles. The system also makes it possible to release the heat stored in the particles to a cold fluid. By a bed of particles is meant a collection of particles arranged in a random manner. The bed of particles can be fixed, mobile, or fluidized.

The solid heat storage particles allow the passage of the fluid in the bed of particles, and during this passage, heat is exchanged between the fluid and the particles. This passage of fluid in the bed of particles can be axial or radial. For the passage of fluid in the bed of particles, the system comprises means for injecting and drawing off the fluid. Preferably, these means for injecting and drawing off are provided at each end of the system for storing and releasing heat, so that the fluid passes through the bed.

According to the invention, the system for storing and releasing heat comprises at each end means for the thermal regulation of the particles. Thus, it is possible to control the temperature of the particles at each end of the bed. Each thermal regulation means ensures a thermal regulation of a portion of the particles of the bed. This control of the temperature allows an optimization of the heat storage, by imposing a temperature on the particles, for example after the charging or the discharging of the system for storing and releasing heat. Thus, the efficiency and the yield of the system for storing and releasing heat are optimized.

According to a first implementation, the system for storing and releasing heat comprises a fixed bed of particles. By fixed bed is meant an arrangement of heat storage particles, in which the particles are immobile.

According to a second implementation, the system for storing and releasing heat comprises a mobile bed of particles. By mobile bed, is meant an arrangement of heat storage particles, in which the particles move in one and the same direction.

According to a third implementation, the system for storing and releasing heat comprises a fluidized bed of particles. A fluidized bed is constituted by a solid phase composed of a flowing fluid phase and particles in suspension in the fluid phase. For example, the fluid phase can be gaseous, in the form of air or an inert gas. The fluid phase can be injected at one end of the heat exchange zone, close to the input (injection) of the particles for forming the fluidized bed. In the case for which the invention uses a “fluidized bed” technology, the system for storing and releasing heat can comprise several fluidized beds “in series”, each input/output fluidized bed comprising a thermal regulation system, that regulates the temperature of the entire fluidized bed.

According to an embodiment of the invention, the heat storage system has a rotational shape, i.e. having an axis of symmetry: cylindrical, conical, tapered, etc., preferably the heat storage means has a substantially cylindrical shape (column). According to an embodiment of the invention, the heat storage means can comprise a plurality of beds of heat storage particles. These beds of particles can form a staged arrangement: the beds are then placed one on top of the other, and can be separated by layers of thermally insulating material. According to an implementation of the invention, the bed of particles can have a substantially cylindrical or annular shape.

According to an implementation of the invention, the system for storing and releasing heat is substantially vertical. Alternatively, the system for storing and releasing heat is substantially horizontal.

According to an embodiment variant of the invention, the heat exchange system according to the invention can comprise solid particles or particles in the form of capsules containing a phase change material (PCM). These materials also allow a reduction in the volume of the optional storage means, as they make it possible to store a large quantity of energy in the form of latent heat. A compromise between efficiency and cost can also be achieved by mixing PCMs and storage materials, using the sensible heat for storing the heat, in the bed of particles. Among the phase change materials, the following materials can be used: paraffins, the melting temperature of which is less than 130° C., salts which melt at temperatures greater than 300° C., (eutectic) mixtures which make it possible to have a wide range of melting temperatures.

The solid particles (whether they are phase change or not) can have all the known shapes of conventional granular media (beads, cylinders, extrudates, trilobes etc.), as well as any other shape making it possible to maximize the exchange surface with the gas. Preferably, the particles are in the form of beads, so as to limit the problems of attrition. The size of particles can vary between 0.02 mm and 50 mm, preferably between 0.5 and 20 mm, and yet more preferably between 1 and 10 mm.

According to an embodiment variant of the invention, the fluid can be a gas, in particular air. The fluid can be a gas to be cooled or heated by the particles in the bed of particles. Alternatively, the fluid can be a liquid.

According to a preferred embodiment of the invention, the system for storing and releasing heat comprises a first thermal regulation means capable of cooling the particles at a first end of the bed of particles, and a second thermal regulation means capable of heating the particles at the other end of the bed of particles. Preferably, the first end corresponds to the side (called “hot side”), through which the hot fluid enters and/or leaves the fixed bed, and the second end corresponds to the side (called “cold side”), through which the cold gas enters and/or leaves the fixed bed. The first thermal regulation means can be utilized in particular after the charging of the system for storing and releasing heat. The second thermal regulation means can be utilized in particular after the discharging of the system for storing and releasing heat. Thus, it is possible to avoid a levelling of the temperature gradient within the bed of particles, which ensures a good maintenance of the thermal gradient in the system for storing and releasing heat. In this way, it is possible to optimize the heat transfer during the charging and discharging of the system for storing and releasing heat. This is particularly important vis-à-vis maintenance of the efficiency of the system during the different charging and discharging cycles, as the storage system must make it possible to ensure a constant temperature at the input of the compressed air storage system (or of the compressor in the case of an AA-CAES process with several compression steps) in the charging phases, and at the input of the expansion turbine during the discharging phases.

Alternatively and/or in addition, the system for storing and releasing heat comprises a first thermal regulation means capable of heating the particles at a first end of the bed of particles, and a second thermal regulation means capable of cooling the particles at the other end of the bed of particles. Preferably, the first end corresponds to the side (called “hot side”), through which the hot fluid enters and/or leaves the fixed bed, and the second end corresponds to the side (called “cold side”), through which the cold gas enters and/or leaves the fixed bed.

In order to maintain the temperature regulated by the thermal regulation means, the bed of particles can comprise at least one layer of thermally insulating material, this layer delimiting the portion of the bed of particles corresponding to the thermal regulation means. These thermally insulating layers make it possible to limit the diffusion of the temperature between the ends of the bed of particles and the centre of the bed of particles, and therefore improve control of the thermal gradient. The insulating material can be any known material of very low thermal conductivity, i.e. more insulating than the bed comprising the particles. This layer of thermally insulating material can be permeable to the fluid, in order to allow its passage through the layer.

Means for measuring the temperature can be provided in the bed of particles. The means for measuring the temperature can be placed at the ends of the bed of particles. These means for measuring the temperature can be used for the thermal regulation of the particles placed at the ends of the bed of particles.

Advantageously, the thermal regulation means can comprise means for heating and/or cooling said particles. These means for heating and/or cooling can comprise a heat exchanger and/or an electrical resistor and/or means for circulating a thermal fluid, etc. By thermal fluid is meant a fluid circulating in a portion of the bed of particles, the purpose of which is to cool or heat the particles. This thermal fluid is different from the fluid which circulates in the bed of particles for its heating or its cooling. The thermal fluid can be air, water, steam or any fluid allowing good heat exchange.

These means for heating and/or cooling can be situated within the bed of particles, so as to optimize heat transfer. Alternatively, the means for heating and/or for cooling can be situated on the periphery of the bed of particles, so as not to hinder the circulation of the heat-exchanging fluid. In this case, the means for heating/and or cooling can be situated between the column and the bed of particles.

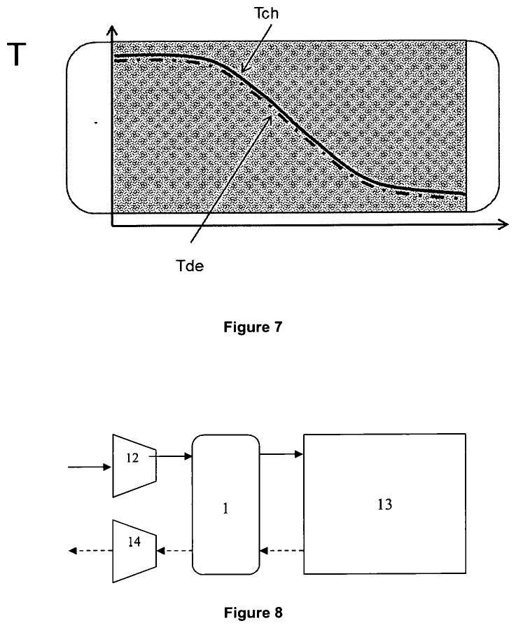

FIG. 7 is a view similar to FIG. 6. This figure shows the “standard” heat profile of a system for storing and releasing heat (TES) in a fixed bed of particles, according to the invention. In this figure, the “hot side” (input and output of the hot fluid) is on the left, and the “cold side” (input and output of the cold fluid) is on the right. In this figure, the curve Tch in a solid line corresponds to the temperature profile during charging, and the curve Tde, in a dotted line, represents the temperature profile during discharging. Thanks to the thermal regulation means, the temperature is almost constant at the ends of the fixed bed. In addition, contrary to the thermal gradient shown in FIG. 6, the thermal gradient is steeper, and the temperature profiles in the charging and discharging phases are closer. Thus, the heat exchanges between the fluid and the particles are more efficient.

According to an implementation of the invention, the thermal regulation means can be utilized in particular during the storage phases (after a charging step), and/or during a waiting step (after a discharging).

FIG. 2 shows, non-limitatively, a system for storing and releasing heat 1 according to a first embodiment of the invention. The storage system 1 is formed by a vertical column, which comprises a fixed bed of particles 2. The column also comprises, at both ends, means for injecting a fluid into and drawing it off 3 from the column. Moreover, the column comprises means for circulating 5 a thermal fluid (i.e. different from the fluid for heating or cooling), in order to ensure the thermal regulation of the particles at the ends of the bed of particles 2. For example, a hot thermal fluid can be injected at the top of the column by the means for injecting and drawing off 3, and can be collected by the means for circulating 5 situated on the periphery of the column, at a short distance from the top of the column. In addition, a cold thermal fluid can be injected by the means for circulating 5 situated on the periphery of the column, at a short distance from the bottom of the column, can be extracted from the column by means for injecting and drawing off 3 at the bottom of the column. Moreover, the bed of particles 2 comprises two layers of thermally insulating material 4. The layers 4 delimit three portions of the bed of particles 2: a first at the upper end of the fixed bed delimited by the top of the column and a first thermally insulating layer 4, a second at the centre of the fixed bed between the two thermally insulating layers 4, and a third at the lower end of the fixed bed delimited by a thermally insulating layer 4 and the bottom of the column. These layers of thermally insulating material make it possible to thermally insulate the portions of the bed of particles, in which the heating and cooling of the particles are provided. Thus, it is possible to maintain the desired thermal gradient.

According to an embodiment variant, the system for storing and releasing heat can comprise no layer or a single layer of thermally insulating material.

Moreover, the fixed bed can be replaced by a mobile bed or a plurality of fluidized beds.

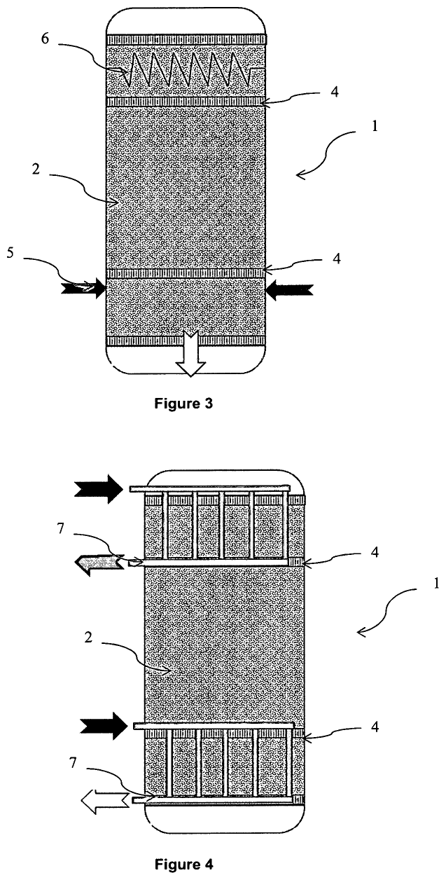

FIG. 3 shows, non-limitatively, a system for storing and releasing heat 1 according to a second embodiment of the invention. The storage system 1 is formed by a vertical column which comprises a fixed bed of particles 2. The column also comprises, at both ends, means for injecting a fluid into and drawing it off from the column. For the “hot side” of the column (at the top of the column), the thermal regulation means comprise an electrical resistor 6, for heating the particles. Moreover, the column comprises means for circulating 5 a thermal fluid (i.e. different from the fluid for heating or cooling), in order to ensure the thermal regulation of the particles on the “cold side” of the bed of particles 2. For example, a cold thermal fluid can be injected using means for circulating 5 situated on the periphery of the column, at a short distance from the bottom of the column, and can be extracted from the column using means for injecting and drawing off at the bottom of the column. Moreover, the bed of particles 2 comprises two layers of thermally insulating material 4. The layers 4 delimit three portions of the bed of particles 2: a first at the upper end of the fixed bed delimited by the top of the column and a first thermally insulating layer 4, a second at the centre of the fixed bed between the two thermally insulating layers 4, and a third at the lower end of the fixed bed delimited by a thermally insulating layer 4 and the bottom of the column. These layers of thermally insulating material make it possible to thermally insulate the portions of the bed of particles, in which the heating and cooling of the particles are provided. Thus, it is possible to maintain the desired thermal gradient.

According to a variant of the embodiment, the system for storing and releasing heat can comprise no layer or a single layer of thermally insulating material.

Moreover, the fixed bed can be replaced by a mobile bed or a plurality of fluidized beds.

FIG. 4 shows, non-limitatively, a system for storing and releasing heat 1 according to a third embodiment of the invention. The storage system 1 is formed by of a vertical column, which comprises a fixed bed of particles 2. The column also comprises, at both ends, means for injecting a fluid and drawing it off from the column. Moreover, the column comprises heat exchangers 7, in order to ensure the thermal regulation of the particles at the ends of the bed of particles 2. For example, a first heat exchanger 7 supplying heat can be situated at the top of the column. In addition, a second heat exchanger, cooling the particles 2 can be situated at bottom of the column. Moreover, the bed of particles 2 comprises two layers of thermally insulating material 4. The layers 4 delimit three portions of the bed of particles 2: a first at the upper end of the fixed bed delimited by the top of the column and a first thermally insulating layer heat 4, a second at the centre of the fixed bed between the two thermally insulating layers heat 4, and a third at the lower end of the fixed bed delimited by a thermally insulating layer 4 and the bottom of the column. These layers of thermally insulating material make it possible to thermally insulate the portions of the bed of particles, in which the heating and cooling of the particles are provided. Thus, it is possible to maintain the desired thermal gradient

According to a variant of the embodiment, the system for storing and releasing heat can comprise no layer, or a single layer of thermally insulating material.

Moreover, the fixed bed can be replaced by a mobile bed or a plurality of fluidized beds.

The embodiments of FIGS. 2, 3 and 4 can be combined by association and/or by replacement, according to all possible combinations. For example, a system for storing and releasing heat can comprise on the “hot side” both an electrical resistor and means for circulating a thermal liquid. According to another example, the system for storing and releasing heat can comprise an electrical resistor on the “hot side”, and a heat exchanger on the “cold side”.

Alternatively, the system for storing and releasing heat can comprise a system of the heat pump type which recovers the excess energy from the “cold side” in order to release it on the “hot side”.

Moreover, the present invention relates to a system for storing and recovering energy by compressed gas equipped with a heat storage means (for example of the AA-CAES type). In this implementation, the gas under pressure (often air) is stored cold. The system for storing and recovering energy according to the invention comprises:
at least one gas compression means (or compressor), and preferably several staged gas compression means. The gas compression means can be driven by a motor, in particular an electric motor;
at least one means for storing the gas (also called reservoir) compressed by the gas compression means. The means for storing the compressed gas can be a natural reservoir (for example an underground chamber) or not. The means for storing the compressed gas can be on the surface or underground. In addition, it can be formed by a single volume or a plurality of volumes connected together or not;
at least one gas expansion means (also called expander or turbine), making it possible to expand and store the compressed gas, and preferably several staged gas expansion means. The gas expansion means allows energy to be generated, in particular electrical energy using a generator;
at least one system for storing and releasing heat, making it possible to store the heat originating from the gas compressed during the energy storage phase, and making it possible to release the heat stored in the compressed gas during the energy releasing phase; the system for storing and releasing heat is, preferably, placed at the output of the compression means and at the input of the expansion means. According to the invention, the heat exchange system comprises solid heat storage particles. These solid particles exchange heat with the gas during the phases of storing and releasing energy, this heat being stored in the particles between these two phases. According to the invention, the heat storage systems are in accordance with one of the embodiment variants described previously, or with one of the combinations of the variants previously described.

The terms “staged compression means” (respectively “staged expansion means”) are used when a plurality of compression means (respectively expansion) are mounted successively one after the other in series: the compressed (respectively expanded) gas at the output of the first compression (respectively expansion) means then passes into a second compression (respectively expansion) means and so on. Then, by a compression or expansion stage is meant one compression or expansion means of the plurality of staged compression or expansion means. Advantageously, when the system comprises a plurality of compression and/or expansion stages, a heat exchange system is placed between each compression and/or expansion stage. Thus, the compressed gas is cooled between each compression, which makes it possible to optimize the yield of the next compression, and the expanded gas is heated between each expansion, which makes it possible to optimize the yield of the next expansion. The number of compression stages and the number of expansion stages can be comprised between 2 and 10, preferably between 3 and 5. Preferably, the number of compression stages is identical to the number of expansion stages. Alternatively, the system for storing and recovering energy by compressed gas (for example of the AA-CAES type) according to the invention can contain a single compression means and a single expansion means.

According to an embodiment variant of the invention, the compression means, staged or not staged, can be reversible, i.e. they can operate both for the compression and for the expansion. Thus, it is possible to limit the number of devices used in the system according to the invention, which allows a gain in weight and in volume of the system according to the invention.

The system according to the invention is suitable for any type of gas, in particular for air. In this case, air at the input used for the compression can be taken from the ambient air, and the air at the output after the expansion can be released into the ambient air. In the remainder of the description, only the embodiment variant with compressed air and its AA-CAES application will be described. However, the system and process for storing energy by compressed gas are valid for any other gas.

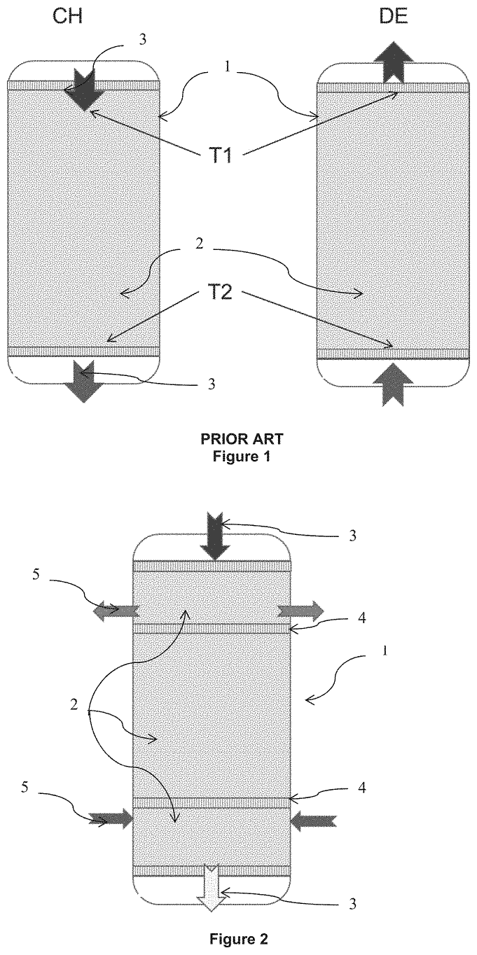

FIG. 8 shows a non-limitative embodiment example of an AA-CAES system according to the invention. In this figure, the solid line arrows show the circulation of the gas during the compression steps (energy storage), and the dotted line arrows show the circulation of the gas during the expansion steps (release of energy). This figure shows an AA-CAES system comprising a single compression stage 12, a single expansion stage 14 and a system for storing and releasing heat 1. The system comprises a storage reservoir 13 for the compressed gas. The system for storing and releasing the heat 1 is inserted between the compression/expansion stage 12 or 14 and the storage reservoir 13 for the compressed gas. In a conventional fashion, in the energy storage phase (compression), the air is firstly compressed in the compressor 12, then cooled in the heat storage system 1. The compressed and cooled gas is stored in the reservoir 13. The heat storage particles of the heat storage system 1 are hot following the cooling of the compressed gas in the compression phase. During the recovery of the energy (expansion), the stored compressed gas is heated in the system for storing and releasing heat 1. Then, in a conventional fashion, the gas passes through one or more of the expansion stages 14 (one stage according to the example shown in FIG. 1).

The system for storing and recovering energy by compressed gas according to the invention is not limited to the example in FIG. 8. Other configurations can be envisaged: a different number of compression and/or expansion stages, the use of reversible means ensuring the compression and expansion, etc.

Alternatively, the system for storing and recovering heat according to the invention can be used for any type of use requiring the storage of heat, in particular for the storage of solar or wind energy, or for any type of industry, for example metallurgy, etc.

In addition, the present invention relates to a process for storing heat, in which the following steps are carried out:

a) circulating a fluid to be cooled in a bed of heat storage particles; and

b) storing part of the heat of the fluid in the particles, and regulating the temperature of the particles at at least one end of the bed of particles, for example by heating the particles situated at the end of the bed of particles through which the fluid leaves (“cold side”).

The process for storing heat according to the invention can also comprise the following steps alone or in combination:
regulating the temperature by heating the particles on the side of the bed through which the hot fluid to be cooled enters, and by cooling the particles on the side of the bed through which the cooled fluid leaves,
regulating the temperature by circulating a thermal fluid in a portion of the bed of particles,
regulating the temperature by supplying an electrical resistance,
regulating the temperature using a heat exchange,
regulating the temperature using a heat pump system.

According to a variant embodiment of this process, during step a), preferably at the end step a), regulating the temperature of the “hot side” of the bed of particles. Preferably, regulating the temperature by heating the particles on the “cold side”.

The heat storage process can be carried out with one of the embodiment variants of the system for storing and releasing heat described previously, or one of the combinations of the variants described previously. In particular, the bed can be a fixed, mobile, or fluidized bed, the particles can comprise phase change materials, the thermal regulation means can comprise a heat pump, an electrical resistor, a heat exchanger and/or means for circulating a thermal fluid.

Moreover, the present invention relates to a process for releasing heat, in which the following steps are carried out:

a) storing part of the heat in particles, and regulating the temperature of the particles at at least one end of the bed of particles; and

b) circulating a fluid to be heated in the bed of particles in order to release the heat to the fluid.

The process for releasing heat according to the invention can also comprise the following steps alone or in combination:
regulating the temperature by heating the particles on the side of the bed through which the cold fluid to be heated enters, and by cooling the particles on the side of the bed through which the heated fluid leaves,
regulating the temperature by circulating a thermal fluid in a portion of the bed of particles,
regulating the temperature by supplying an electrical resistance, regulating the temperature using a heat exchange,
regulating the temperature using a heat pump system.

According to an embodiment variant of this process, during step b), preferably at the end of step b) and after step b), the temperature of the “hot side” of the bed of particles can be regulated. Preferably, the temperature is regulated by cooling the particles of the “hot side”.

The process for releasing the heat can be carried out with one of the embodiment variants of the system for storing and releasing heat described previously, or one of the combinations of the variants described previously. In particular, the bed can be a fixed, mobile, or fluidized bed, the particles can comprise phase change materials, the thermal regulation means can comprise a heat pump, an electrical resistor, a heat exchanger and/or means for circulating a thermal fluid.

The invention also relates to a process for storing and releasing heat which is formed by the succession of steps of the process for storing heat and the process for releasing heat.

By “cycle” is then meant this succession of four steps:

1) charging (cooling the fluid),

2) storing and thermal regulation,

3) discharging (heating the fluid), and

4) waiting and optionally thermal regulation.

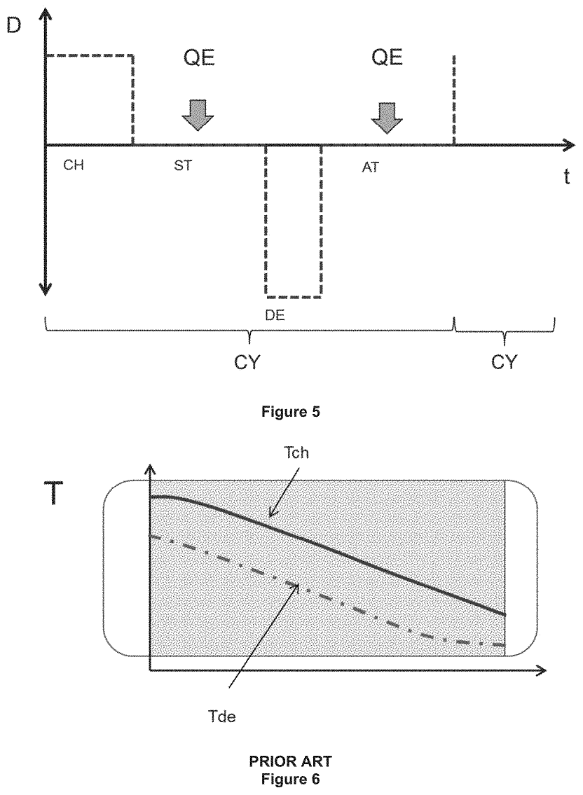

FIG. 5 shows, non-limitatively, these four steps of the cycle CY according to the invention. FIG. 5 shows a curve of the flow rate D as a function of time. During the first charging step CH, the fluid circulates in a first direction in the bed, which by convention is indicated by a positive flow rate. During the second step, the heat is stored ST, without fluid passing. During this storage step ST, a thermal regulation QE is implemented. Then, a discharging step DE is carried out; the fluid then circulates in a direction opposite to the first direction of the charging step, which is indicated by a negative flow rate. Then a waiting step AT with a thermal regulation QE is implemented, without fluid passing. The waiting step ends with the start of a new cycle CY.

According to an embodiment of the invention, the thermal regulation can also be carried out during the charging and discharging steps, preferably at the end of charging and discharging steps.

For example, during charging, the temperature of the “cold side” of the bed of particles can be regulated, preferably, by heating the particles on the “cold side”, and, during discharging, the temperature of the “hot side” of the bed of particles can be regulated, preferably, by cooling the particles on the “hot side”.

The present invention also relates to a process for storing and recovering energy by compressed gas, in which the following steps are carried out:
a) compressing a gas, in particular using a compressor;
b) cooling the compressed gas by heat exchange, in a system for storing and releasing heat according to the invention;
c) storing the cooled compressed gas, in particular using a means for storing compressed gas;
d) heating the stored compressed gas, by heat exchange, in the system for storing and releasing heat according to the invention; and
e) expanding the heated compressed gas in order to generate energy, for example using a turbine for generating electrical energy.

According to the invention, the heat exchange between the gas and the particles is carried out with a thermal regulation of the ends of the bed of particles of the system for storing and releasing heat. Thus, the storing and releasing of energy of the process of the AA-CAES type are optimized.

According to an implementation of this process, the temperature of the bed of particles is regulated by heating the particles at the end of the bed of particles through which the gas has entered, and by cooling the particles at the end of the fixed bed through which the gas has left.

The process for storing storage and recovering energy by compressed gas can be carried out with one of the embodiment variants of the system for storing and releasing heat described previously, or one of the combinations of the variants previously described. In particular, the bed can be a fixed, mobile, or fluidized bed, the particles can comprise phase change materials, the thermal regulation means can comprise a heat pump, an electrical resistor, a heat exchanger and/or means for circulating a thermal fluid.

According to an aspect of the invention, the process comprises several successive compression steps, using compressors placed in series, also called staged compressions. In this case, steps a) and b) are repeated for each compression stage. Thus, the gas is compressed and cooled several times.

According to a characteristic of the invention, the process comprises several successive expansion steps, using expansion means placed in series, also called staged expansions. In this case, steps d) and e) are repeated for each expansion stage. Thus, the gas is heated and expanded several times.

Step a) relates to the compression of a gas, for example air. It can be in particular air taken from the ambient environment.

Step b) makes it possible to cool the compressed gas after each compression step, which makes it possible to optimize the yield of the next compression and/or the energy storage. The heat storage system makes it possible, during storage of the compressed gas (compression), to recover a maximum amount of heat originating from the compression of the gas at the output of the compressors and to reduce the temperature of the gas before passing to the next compression or before storage. For example, the compressed gas can pass from a temperature greater than 150° C., for example approximately 190° C. to a temperature of less than 80° C., for example approximately 50° C.

Step c) can be carried out using means for storing the compressed gas, which can be a natural reservoir or not (for example an underground chamber). The means for storing the compressed gas can be on the surface or underground. In addition, it can be formed by a single volume or a plurality of volumes connected together or not. During storage, the means for storing the compressed gas are closed.

The compressed gas is stored until the time when it is desired to recover the stored energy. Step d) and the following steps are carried out at the time when it is desired to recover the stored energy.

Step d) makes it possible to heat the compressed air before each expansion, which makes it possible to optimize the yield of the next expansion. For step d), the heat storage particles which have been used for cooling during step b) can be used. The heat storage means makes it possible, during the release of the energy, to release a maximum amount of heat stored by increasing the temperature of the gas before passing to the next expansion. For example, the gas can pass from a temperature of less than 80° C., for example approximately 50° C., to a temperature greater than 150° C., for example approximately 180° C.

During step e), the compressed gas is expanded. The expansion of the compressed gas makes it possible to generate energy. This expansion can be carried out using a turbine which generates electrical energy. If the gas is air, the expanded air can be discharged into the ambient environment.

The process and system for storing and recovering energy by compressed gas according to the invention can be used for the storage of intermittent energy, such as wind or solar energy, in order to be able to use this energy at the desired time.

1. System for storing and releasing heat comprising at least one bed of particles for storing heat, and means for injecting a fluid into and drawing it off from the bed of particles, wherein the system for storing and releasing heat comprises at each end of the bed of particles a means for thermal regulation of the particles.

2. System according to claim 1, in which the storage system comprises a first means for thermal regulation capable of heating the particles at a first end of the bed of particles, and a second means for thermal regulation capable of cooling the particles at a second end of the bed of particles.

3. System according to claim 1, in which the means for thermal regulation comprises means for heating and/or cooling the particles.

4. System according to claim 2, in which the means for heating and the means for cooling of the first and second means for thermal regulation are connected using a heat pump device.

5. System according to claim 3, in which the means for heating and/or for cooling the particles comprise a heat exchanger and/or an electrical resistor and/or means for circulating a thermal fluid.

6. System according to claim 3, in which the means for heating and/or for cooling are situated within the bed of particles.

7. System according to claim 3, in which the means for heating and/or cooling are situated on the periphery of the bed of particles.

8. System according to claim 1, in which the fixed bed comprises a layer of thermally insulating material, within the bed of particles, delimiting the means for thermal regulation.

9. System according to claim 1, in which the system for storing and releasing heat comprises means for measuring the temperature of the particles.

10. System according to claim 1, in which the fluid is a gas, in particular air.

11. System according to claim 1, in which the particles are particles of phase change material.

12. System for storing and recovering energy by compressed gas comprising at least one gas compression means, at least one means for storing compressed gas, at least one means for expanding the compressed gas in order to generate energy, and at least one system for storing and releasing heat according to claim 1.

13. Process for storing heat, wherein it comprises the following steps:
a) circulating a fluid in a bed of particles for storing heat of a system for storing and releasing heat according to claim 1; and
b) storing part of the heat of the fluid in the particles, and regulating the temperature of the particles at at least one end of the bed of particles.

14. Process for releasing heat, wherein it comprises the following steps:
a) storing heat in a bed of particles for storing heat of a system for storing and releasing heat according to claim 1, by regulating the temperature of the particles at at least one end of the bed of particles; and
b) circulating a fluid in the bed of particles in order to release the heat from the particles to the fluid.

15. Process for storing and recovering energy by compressed gas, wherein it comprises the following steps using a system for storing and recovering energy by compressed gas according to claim 12:
a) compressing a gas;
b) cooling a gas in a system for storing and releasing heat;
c) storing the cooled gas;
d) heating the cooled gas in the system for storing and releasing heat; and
e) expanding the heated compressed gas in order to generate energy.

16. Process according to claim 15, in which between the steps of cooling the gas and heating the gas, the temperature at at least one end of the bed of particles is regulated.

17. Process according to claim 16, in which, in step b), the temperature of the bed of particles is regulated by heating the particles at the end of the bed of particles through which the gas has left.

18. Process according to claim 16, in which, in step d), the temperature of the bed of particles is regulated by cooling the particles at the end of the bed of particles through which the gas has left.
